(19) United States
(12) Patent Application Publication
(10) Pub. No.: US 2004/0221035 A1
(43) Pub. Date: Nov. 4, 2004

(54) Remote-support system for an analysing apparatus

(75) Inventor: Tsuyoshi Morikawa, Kyoto-fu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shimadzu Corporation, Kyoto (JP)

(21) Appl. No.: 10/833,014

(22) Filed: Apr. 28, 2004

(30) Foreign Application Priority Data
May 1, 2003 (JP) 2003-126243(P)

(51) Int. Cl. G06F 15/173; G06F 15/16

(52) U.S. Cl. 709/224; 709/203

(57) ABSTRACT

The present invention provides a remote support system for diagnosing or analyzing a fault of an analyzing apparatus from a remote service support terminal without lowering the security of the user's intranet. In an embodiment of the invention, the system includes an analyzing apparatus 8 having a communication controller 81 and connected via the user's intranet 7 to the Internet 1, a terminal 5a or 5b connected via the manufacturer's intranet 4 to the Internet 1, and a server 2 accessible through the Internet 1. In a polling communication, the terminal 5a or 5b as the master sends a control command to the server 2 as the slave. In another polling communication, the analyzing apparatus 8 as the master receives the control command from the server 2 as the slave. Such a two-stage communication process makes it possible to control the analyzing apparatus 8 for the purpose of analyzing the log or maintenance information and troubleshooting the problem while maintaining the security level of the intranet 7.

The present invention relates to a remote support system for an analyzing apparatus, which enables service persons or engineers to diagnose the fault of a remote liquid chromatograph or other types of analyzing apparatuses or update the control program of the analyzing apparatus.

### BACKGROUND OF THE INVENTION

In conventional cases, when the user (either a person or corporation) has encountered a fault or trouble of unknown origin of a liquid chromatograph or other types of analyzing apparatuses, the user usually contacts a support person of the manufacturer of the analyzing apparatus to come to the place where the analyzing apparatus is located. In such a case, it usually takes some time for the service person to reach the place, so that the problem cannot always be immediately addressed. Therefore, the user is often forced to waste some time until the analyzing apparatus is repaired. Moreover, since modern analyzing apparatuses have sophisticated and complicated functions, the on-site examination by the service person often fails to provide a good solution for the problem, and the analyzing apparatus often has to be examined by the engineers in charge of the development or designing of the apparatus. In the case where the engineer has to visit the user, it takes longer time to solve the problem, and the user will have more dissatisfaction.

To address the aforementioned problems, there are some systems whereby the user-side computer for controlling the analyzing apparatus is connected to a manufacturer-side computer via a communication link, such as the Internet, to transmit the fault information between the two computers, either on-line or off-line, so that the user-side computer can be inspected with the manufacturer-side computer (see, for example, the Japanese Unexamined Patent Publication No. H10-228311).

To control the analyzing apparatus located on the user side from the service person's computer, however, the user must permit the service person to access the user's intranet. It is practically impossible to build a system that allows outsiders to access the intranet because, in that case, there is a high probability that a security problem arises even if the person is duly bound by the duty to keep secret. Therefore, the system disclosed in the aforementioned Japanese Unexamined Patent Publication uses an e-mail system to transmit the information. E-mails, however, do not always immediately reach the receiver.

Therefore, if a service person or engineer needs to concentrate on the supporting work of a certain analyzing apparatus within a fixed period of time, e-mail is not an efficient communication tool.

To solve the above-described problem, the present invention provides a remote support system for an analyzing apparatus that can promptly provide the analyzing apparatus with necessary services, such as fault diagnosis or program updates, from an external computer without lowering the security of the user's intranet.

### SUMMARY OF THE INVENTION

To solve the aforementioned problem, the present invention provides a remote support system for an analyzing apparatus for carrying out the fault diagnosis, repairing, program updates and/or other support services of the analyzing apparatus located on the user's side from an external computer, which includes:

a communication unit provided to the analyzing apparatus and connected via a user's closed network to the Internet;

a service support terminal connected via the user's closed network or a different network to the Internet, or directly to the Internet; and

a server used for providing support services, where the server is open to the Internet;

wherein the service support terminal and the communication unit of the analyzing apparatus send and receive information from and to each other by way of the server by a process including a first polling step in which the communication unit of the analyzing apparatus acts as the master and the server acts as the slave and a second polling step in which the service support terminal acts as the master and the server acts as the slave.

In the remote support system according to the present invention, when, for example, a predetermined control command is to be sent from the service support terminal to the analyzing apparatus, the service support terminal sends the control command to the server as a polling request signal. In response to this signal, the server returns an acknowledgement signal to the service support terminal. The control command is temporarily maintained on the server. In the meantime, the communication unit of the analyzing apparatus sends a polling request signal to the server at predetermined intervals of time. When the server has received the request signal from the communication unit of the analyzing apparatus while the control command is maintained thereon, the server sends the control command to the analyzing apparatus. Even if the network has a firewall (or proxy server having similar functions) located at its gateway, the firewall does not block the control signal but allows it to pass through because the signal is a due response to the polling request signal that has originated from the inside of the network. Thus, the analyzing apparatus can receive the control command and perform the operation indicated by the command. Taking the above-described steps in reverse order will make it possible to send the operation logs, analysis condition files and other data stored in the analyzing apparatus to the service support terminal by way of the server.

The firewall blocks any unauthorized access from the Internet to the user's network. While ensuring the high level of security of the user's network, the firewall allows the information necessary for analyzing the trouble of the analyzing apparatus, repairing the analyzing apparatus or updating a software program to be assuredly transferred between the analyzing apparatus and the support service terminal, as described above. Using this mechanism, the manufacturer can provide the user with appropriate support services from a remote terminal, and the user can have confidence about the network security.

In the remote support system for analyzing apparatus according to the present invention, the server may be preferably constructed to allow multiple service support terminals to simultaneously send the polling request signals addressed to the same analyzing apparatus. This construction allows the service person to cooperate with another person belonging to a quality assurance division or engineering division to simultaneously troubleshoot the problem of the same analyzing apparatus.

### BRIEF DESCRIPTION OF THE DRAWINGS

FIG. 1 is a schematic diagram showing the general construction of a remote support system for analyzing apparatus as an embodiment of the present invention.

FIG. 2 is a block diagram showing the functional construction of the analyzing apparatus in the remote support system for analyzing apparatus of the embodiment.

FIG. 3 is a communication state diagram showing an example of the operation of the system shown in FIG. 1.

FIG. 4 is a schematic diagram showing the general construction of a remote support system for analyzing apparatus as a modified embodiment of the present invention.

FIG. 5 is a schematic diagram showing the general construction of a remote support system for analyzing apparatus as another modified embodiment of the present invention.

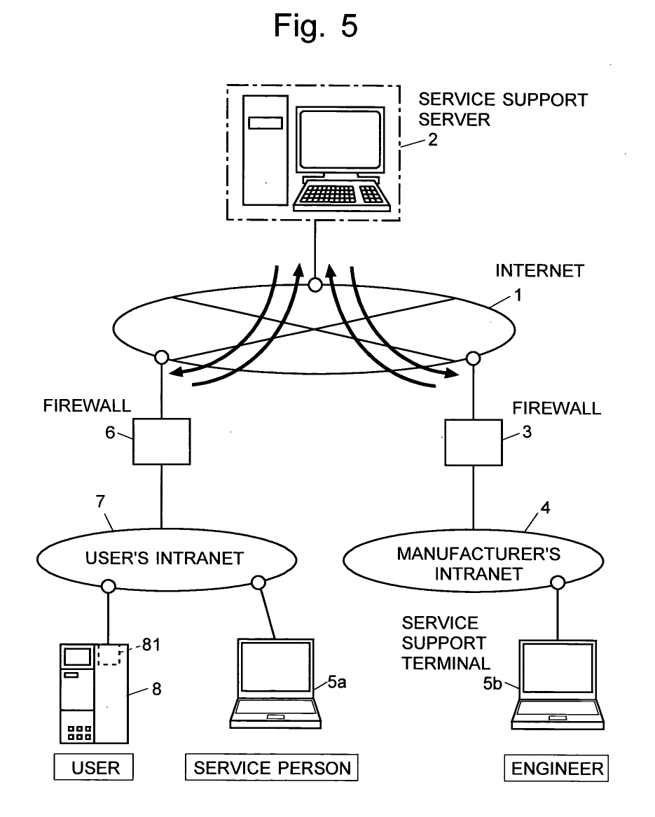

### DETAILED DESCRIPTION OF PREFERRED EMBODIMENTS

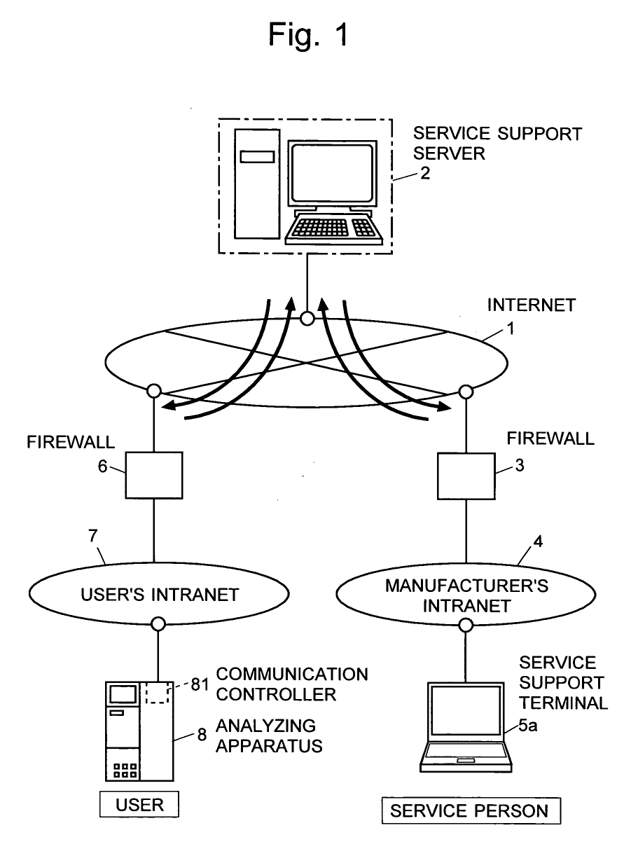

FIG. 1 is a schematic diagram showing the general construction of a remote support system for analyzing apparatus as an embodiment of the present invention. This system includes the following elements: an analyzing apparatus 8, owned by a user, having the function of accessing the Internet 1 via a user's intranet (local area network) 7; a service support terminal 5a having the function of accessing the Internet 1 via a manufacturer's intranet 4, and this intranet is independent of the user's intranet 7; and a support service server 2, which is directly connected to the Internet 1, for providing a communication link between the analyzing apparatus 8 and the terminal 5a. The intranets 4 and 7 have firewalls 3 and 6 located at the gateways between the Internet 1 and the intranets 4 and 7, respectively, to prevent unauthorized accesses to the intranets 4 and 7 from the Internet 1. The firewalls 3 and 6 may be replaced by proxy servers or similar systems.

The server 2, which is a computer connected to the Internet 1, has a predetermined server program installed inside. Running the program on the server 2 will enable the server 2 to control the transmission of data relating to the support services, such as troubleshooting, as described later. The terminal 5a is a personal computer with a predetermined program installed inside. Running the program on the terminal 5a will enable the terminal 5a to process the polling communication, which will be described later.

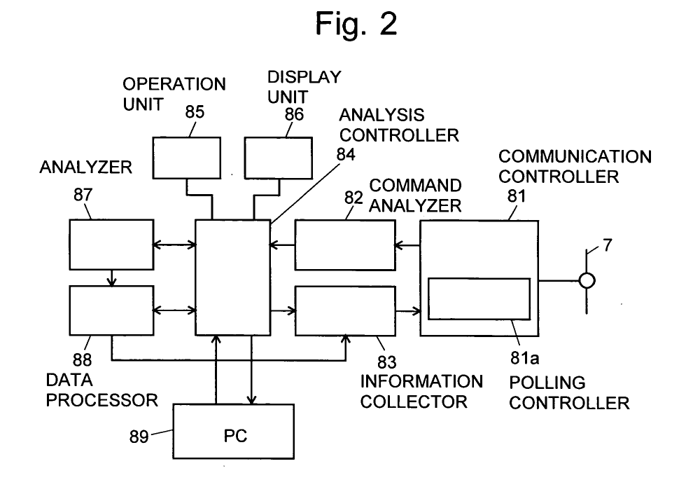

FIG. 2 is a block diagram showing an example of the functional construction of the analyzing apparatus 8. In FIG. 2, the analyzer 87 carries out an analysis of an object and produces analysis data, which is analyzed by the data processor 88. The analysis controller 84 controls the operations of the analyzer 87 and the data processor 88. The operation unit 85 having operation keys (not shown) and the display unit 86 having a screen (not shown) are connected to the controller 84. The communication controller 81, which is connected to the user's intranet 7 or similar external network, includes a polling controller 81a as a function unit for carrying out the polling communication, which will be described later. Various control commands received from the intranet 7 via the polling controller 81a are decoded by the command analyzer 82 and sent to the analysis controller 84. The analysis data obtained by the data processor 88 and other operation data produced by the analysis controller 84, including operation logs, maintenance logs and analysis condition files, are collected by the information collector 83 and sent out to the intranet 7 via the communication controller 81. As shown in FIG. 2, it is also possible to connect a personal computer (PC) 89 to the analysis controller 84 and use the PC 89 to control the overall operation of the analyzer 87. The PC 89 may be also constructed to carry out the analysis in place of the data processor 88 and/or carry out more complicated data processing.

In this remote support system, the analyzing apparatus 8 has its own built-in communication function. Therefore, the analyzing apparatus 8 can access the Internet 1 via the intranet 7 without using the hardware or software of the PC 89, irrespective of whether or not the PC 89 is connected to it. However, the communication controller 81 has only a limited range of communication functions compared to those implemented in normal personal computers. For example, the analyzing apparatus 8 cannot access the other personal computers via the intranet 7, so that it cannot gather any information from those computers. The communication function of the communication controller 81 is implemented as a control program written in a read-only memory (ROM) or similar memory device. Therefore, it is impossible to change the communication protocol or load a different program without taking a specific process to rewrite the content of the ROM. Such constructions prevent the intrusion of malicious third parties through the analyzing apparatus 8 into some other personal computer connected to the intranet 7, even if it is possible to access the analyzing apparatus 8 from the Internet 8 by utilizing the polling communication described later.

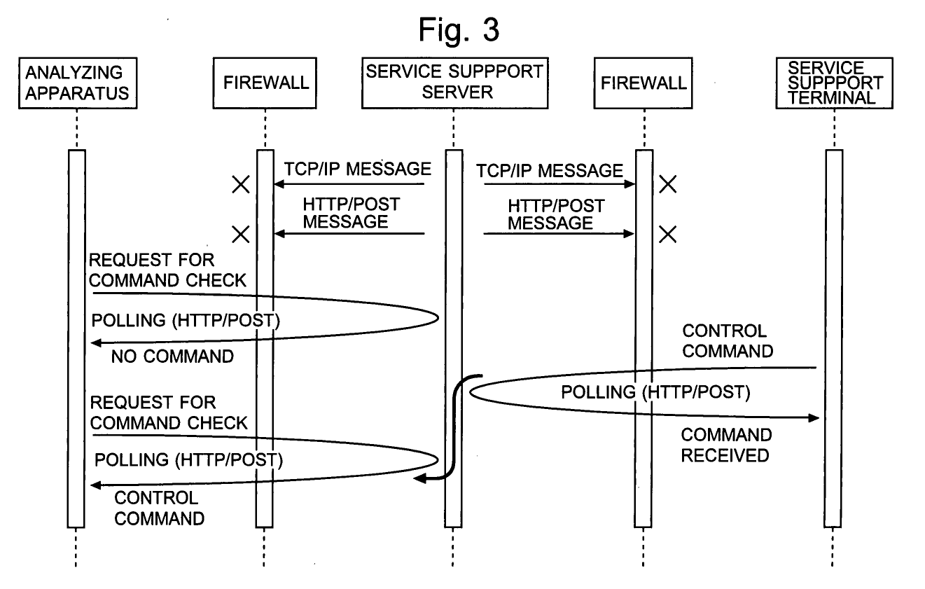

An example of the operation of the remote support system having the above-described construction is explained below. FIG. 3 is a communication state diagram for illustrating the operation of the system according to this embodiment where the system provides a fault diagnosis or other support services to the analyzing apparatus 8.

Since the present system has firewalls 3 and 6 located at the gateways of the intranets 4 and 7, any TCP/IP or HTTP/POST message from the Internet 1 is blocked if the message has not been produced by taking due steps. Therefore, nobody can directly access the analyzing apparatus 8 from the terminal 5a or 5b via the Internet 1.

Assume that a fault or trouble of unknown origin has occurred to the analyzing apparatus 8: In such a case, the user contacts the manufacturer by phone, email or other media to ask for a support service including the fault analysis. On the manufacturer's side, a service person prepares for the service and then carries out the support service by the following steps: That is, the support person requests the user to run the service support program on the analyzing apparatus 8 and connect to the Internet 1 to log on the server 2. Also, the support person logs on the server 2 from the terminal 5a via the Internet 1.

Thus, two communication links are established, one connecting the terminal 5a and the server 2 and the other connecting the analyzing apparatus 8 and the server 2. The first link is for the polling communication between the terminal 5a as the master and the server 2 as the slave, in which the terminal 5a sends a polling request signal to the server 2 as an HTTP/POST message and receives the response to the request. The second link is for the polling communication between the analyzing apparatus 8 as the master and the server 2 as the slave, in which the analyzing apparatus 8 sends a polling request signal to the server 2 an HTTP/POST message the and receives the response to the request.

For example, if the service person needs to remotely control the analyzing apparatus 8 from the terminal 5a to run a predetermined fault diagnosis program, the service person sends a request indicative of the control command for running the program from the terminal 5a to the server 2. In response to this request, the server 2 returns a response data indicative of the receipt of the command to the terminal 5a. With this response, the service person using the terminal 5a recognizes that the control command has been successfully transmitted to the server 2. The control command is maintained on the server 2 for only a short period of time until the command is read out as described later.

Independent of the polling communication between the terminal 5a and the server 2, the analyzing apparatus 8 sends a request to the server 2 at short intervals of time to check whether there is any control command addressed to that analyzing apparatus 8. As shown in FIG. 3, the server 2 returns a response indicative of the absence of the command when no control command addressed to that analyzing apparatus 8 is present on the server 2. When, on the other hand, the server 2 has a control command, the server 2 sends the control command to the analyzing apparatus 8 as the response. The shorter the interval of time is for the polling communication between the analyzing apparatus 8 and the server 2, the shorter the period of time becomes for the server 2 to maintain the control command. In practice, the transmission of the control command from the terminal 5a via the server 2 to the analyzing apparatus 8 can be practically real-time.

When the control command has been transmitted to the analyzing apparatus 8, the command analyzer 82 decodes the command and automatically carries out the operation indicated by the control command. Thus, the remote control of the analyzing apparatus 5a from the terminal 5a is accomplished. Taking the above-described steps in reverse order will make it possible to send various kinds of data relating to the analysis, collected by the information collector 83 within the analyzing apparatus 8, to the server 2, which temporarily maintains the data and sends it to the terminal 5a in response to a request that the terminal 5a sends to the server 2 at predetermined intervals of time. Thus, the service person can make appropriate services even from a remote place by sending and receiving data between the terminal 5a and the analyzing apparatus 8 by way of the server 2.

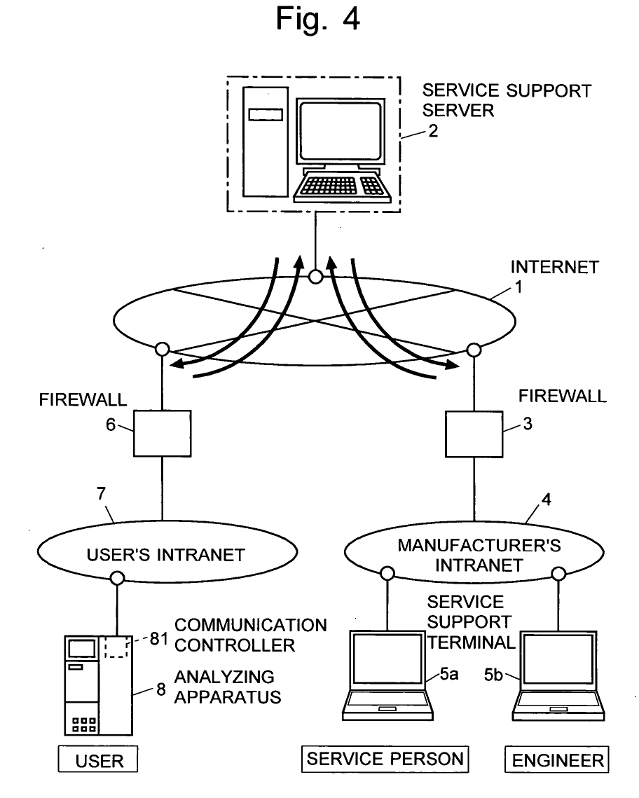

In the above-described embodiment, there is only one terminal 5a connected to the manufacturer's intranet 4. It is also possible to simultaneously connect two or more terminals 5a and 5b to the intranet 4, as shown in FIG. 4. This construction allows the service person to do the troubleshooting or other services of the analyzing apparatus in collaboration with a remote engineer having a high level of knowledge about the analyzing apparatus 8.

The terminals 5a and 5b may be directly connected to the Internet 1 by way of a commercial network service provider as well as the manufacturer's intranet 4. In some circumstances, the terminal is connected to the user's intranet 7. This construction allows such a joint effort where the service person visits the user, operates the analyzer 8 and sends necessary information through the terminal 5a to the remote engineer, who in turn supports the service person by remote-controlling the analyzing apparatus 8 based on the received information. Even when, as in the previous case, the terminal 5a and the analyzing apparatus 8 are connected to the same network, i.e. the intranet 7, it is preferable that the terminal 5a does not directly communicate with the analyzing apparatus 8 but always sends and receives necessary data via the server 2. This policy reduces the distrust of the user with respect to the service person's access to other analyzing apparatus or personal computers connected to the intranet 7.

In the above-described embodiments, the user's intranet 7 includes only one analyzing apparatus 8. It is also possible to simultaneously use one terminal 5a to remotely control or diagnose plural analyzing apparatuses 8 connected to the intranet 7.

It should be noted that the above-described embodiments are mere examples of the present invention, and they may be changed, modified or include additional features in some other aspects within the scope of the present invention.

What is claimed is:

1. A remote support system for an analyzing apparatus for carrying out a fault diagnosis, repairing, program updates and/or other support services of the analyzing apparatus located on a user's side from an external computer, the system comprising:
a communication unit provided to the analyzing apparatus and connected via a user's closed network to the Internet;
a service support terminal connected via the user's closed network or a different network to the Internet, or directly to the Internet; and
a server used for providing support services, the server being open to the Internet;
wherein the service support terminal and the communication unit of the analyzing apparatus send and receive information from and to each other by way of the server by a process including a first polling step in which the communication unit of the analyzing apparatus acts as a master and the server acts as a slave and a second polling step in which the service support terminal acts as a master and the server acts as a slave.

2. The remote support system according to claim 1, wherein the server is constructed to allow a plurality of service support terminals to simultaneously send the polling request signals addressed to the same analyzing apparatus.

3. The remote support system according to claim 1 or 2, wherein the communication unit of the analyzing apparatus is implemented as a control program written in a read-only memory.

4. The remote support system according to claim 1 or 2, further comprising a firewall or proxy server located at a gateway of the user's closed network.
